(19) United States
(12) Patent Application Publication
(10) Pub. No.: US 2014/0134958 A1
(43) Pub. Date: May 15, 2014

(54) Dual Feed Antenna System

(71) Applicant: Futurewei Technologies, Inc., Plano, TX (US)

(72) Inventors: Jorge Fabrega Sanchez, San Diego, CA (US); Kiran Vanjani, San Diego, CA (US)

(21) Appl. No.: 13/673,862

(22) Filed: Nov. 9, 2012

(51) Int. Cl. H04B 1/10; H01Q 3/24

(52) U.S. Cl. CPC H04B 1/1027; H01Q 3/24
USPC 455/73; 343/876; 343/867

(57) ABSTRACT

In one embodiment, the disclosure includes an apparatus for use in a wireless communication device comprising a plurality of antennas, and a selection switch coupled to the plurality of antennas, wherein the selection switch is configured to select a first antenna for use when the wireless communication device is in use in a first physical orientation with respect to a user, and select a second antenna for use when the wireless communication device is in use in a second physical orientation with respect to a user, and wherein the first physical orientation is different from the second physical orientation.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Advances in wireless communication have revolutionized the way we communicate and access information, and have birthed a variety of wireless capable consumer devices. In modern wireless communication systems, a variety of input/output (I/O) components and user interfaces are used in a wide variety of electronic devices. Portable wireless communication devices such as a smartphone increasingly integrate a number of functionalities (e.g., global positioning system (GPS), wireless local area networks (WLAN or Wi-Fi), Bluetooth, cellular communication, near field communication (NFC), etc.).

An antenna can be used to transmit or receive radio frequency (RF) signals in the range of about 3 kilohertz (KHz) to 300 gigahertz (GHz). Cellular communications within the United States generally use a frequency range between 698 and 5000 megahertz (MHz). Modem wireless communication devices use numerous types of antennas, including dipole antennas (e.g., short dipole, half-wave dipole, folded dipole, broadband dipoles), monopole antennas, small loop antennas, rectangular microstrip (or patch) antennas, planar inverted-F antennas (PIFA), helical antennas, spiral antennas slot antennas, cavity-backed slot antennas, inverted-F antennas (IFA), slotted waveguide antennas, and near field communications (NFC) antennas, including various combinations thereof.

### SUMMARY

In one embodiment, the disclosure includes an apparatus for use in a wireless communication device comprising a plurality of antennas, and a selection switch coupled to the plurality of antennas, wherein the selection switch is configured to select a first antenna for use when the wireless communication device is in use in a first physical orientation with respect to a user, and select a second antenna for use when the wireless communication device is in use in a second physical orientation with respect to a user, and wherein the first physical orientation is different from the second physical orientation.

In another embodiment, the disclosure includes an apparatus comprising a common ground line, a first loop antenna coupled to the common ground line with a feed port, wherein the first loop antenna is configured to communicate using a first frequency, a second loop antenna coupled to the common ground line with a feed port, wherein the second loop antenna is configured to communicate using the first frequency, and a selection switch coupled to the common ground line, wherein the selection switch is configured to select between use of the first loop antenna or second loop antenna.

In a third embodiment, the disclosure includes a method of communicating on a wireless communication device comprising configuring a wireless communication device to communicate using a first antenna on a first frequency, receiving input from a sensor, wherein the sensor provides indication of a physical orientation of the wireless communication device with respect to a user, and reconfiguring the wireless communication device to communicate using a second antenna on the first frequency based on the input from the sensor.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a front perspective view of an embodiment of a handheld wireless communication device.

FIG. 2 is a schematic diagram of an embodiment of a wireless communication device.

FIG. 3 depicts an embodiment of a seven-band surface mount loop antenna with a capacitively coupled feed for mobile phone applications.

FIG. 4 depicts an embodiment and detail of a dual-polarized dual-loop antenna system for 2.4/5 GHz WLAN access points.

FIG. 5A depicts a rear view of a wireless communication device having an embodiment of a dual feed antenna system.

FIG. 5B depicts a detail view of the antenna subsystem of FIG. 5A.

FIG. 6 depicts an embodiment of a dual feed antenna system and switch for selecting between two antennas.

FIG. 7A depicts a right-side in-use wireless communication device.

FIG. 7B depicts a left-side in-use wireless communication device.

FIG. 8 depicts a flowchart of an embodiment of a method for a dual feed antenna system.

FIG. 9A is a return loss plot depicting free space performance of a first antenna over a range of frequencies.

FIG. 9B is a return loss plot depicting free space performance of a second antenna over a range of frequencies.

FIG. 9C is a plot depicting the antenna efficiency of a first and second antenna in free space, in obstructed real-world, and in non-obstructed real-world environments.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Signal obstruction degrades wireless communication device transmission efficiency. This disclosure includes systems and methods for switching between opposing antennas sharing an overlapping frequency band to minimize obstruction, e.g., hand and/or head obstruction, of the relevant communications signals. Systems and methods disclosed herein include an antenna configuration comprising two symmetrical antennas having a common ground which, based on external parameters, e.g., orientation of the device with respect to a user, are selectively employed for optimal transmission and/or receipt of data signals. For example, a cell phone may include two loop antennas with two distinct feed points and one common ground arranged in symmetrical configuration with respect to the length centerline of a mobile phone. When the phone is in use, the head-relative location of the device is determined and a high-side antenna is used for transmission to minimize biological occlusion of the transmitted signal. One method to estimate the head relative location of a handset is described in U.S. patent application Ser. No. 13/673,835, which is incorporated herein by reference. In some embodiments, the dual feed antenna system occupies the same volume typically occupied by only one antenna.

The system and method may be implemented in a wireless communication device used to transmit and receive radio frequency (RF) signals. The wireless communication device may be a handheld device, such as a cellular phone. The wireless communication device may be equipped with multiple-axis (multiple-dimension) input systems, such as a display, a keypad, a touch screen, an accelerometer, a gyroscopic sensor, a Global Positioning System (GPS), a microphone, and/or a wireless interface (e.g., a Wi-Fi connection and/or a telecommunications interface).

This disclosure discusses various obstruction of a wireless communication device transmission, e.g., obstruction due to a user's body, in the context of head-relative positions and cellular telephones by way of example and not of limitation. For example, the wireless communication device may comprise various types of handheld or personal devices, such as portable two-way radio transceivers (e.g., a “walkie-talkie”), cellular telephones, tablet computers, personal digital assistants (PDAs), dictaphones, global positioning system units, garage door openers, wireless computer mice, wireless keyboards, wireless computer accessories, television remote controls, wireless keys, and cordless telephones. Similarly, while references to the “head” and “hand” are used for convenience, any body part, e.g., arm, leg, etc., may be substituted as needed for a base of reference. A person having ordinary skill in the art would recognize that implementing the disclosed method in any other type of wireless communication device and using another anatomical or wireless communication device-external frame of reference is within the scope of this disclosure.

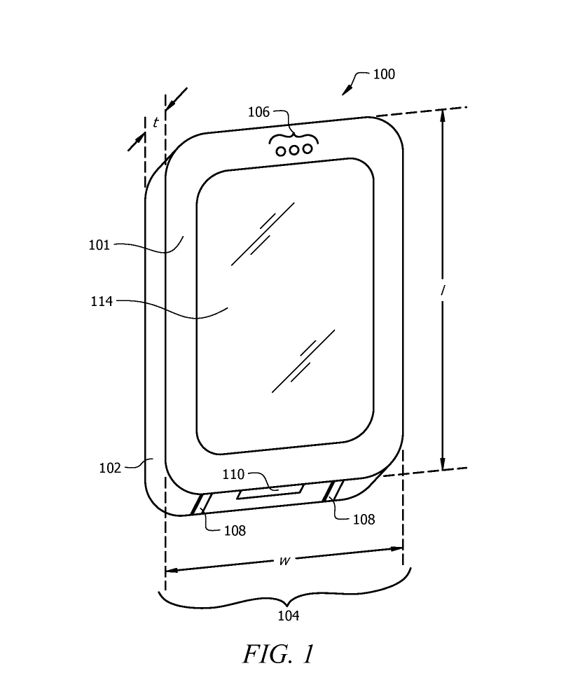

FIG. 1 is a front perspective view of an embodiment of a handheld wireless communication device 100. The wireless communication device 100 may comprise a housing 101. The housing 101 may be a casing that forms the external surface of the wireless communication device 100, and comprise a plurality of edges 102 along a perimeter of the wireless communication device 100. The edges 102 may include a bottom edge 104, two side edges, and a top edge opposite to the bottom edge 104. The wireless communication device 100 may also comprise one or more I/O ports 110 that may be located on one external surface, e.g., along the edges 102, and one or more I/O apertures 106 on a front panel 114, and 108 on an edge 102 of the device. The apertures 106 and 108 may support one or more speakers or microphones (not shown) that may be located inside the wireless communication device 100. The front panel 114 may comprise a touch screen panel and, optionally, a plurality of input buttons (e.g., a QWERTY keyboard). One or more input buttons (not shown) may be located on the edges 102 as well.

The shape of the housing 101 may vary according to the different designs, e.g., for different device types and/or manufacturers. The shape may be any three-dimensional shape, but is generally rectangular or cuboid. In one embodiment, the housing 101 may have a generally rectangular cuboid shape with rounded corners. The dimensions of the housing 101 may also vary. In one embodiment, the generally cuboid shape may have a thickness (t) of about 10 millimeters, length (1) of about 110 millimeters, and width (w) of about 60 millimeters. In other embodiments, the dimensions of the housing 101 may have different values but with similar ratios as above or with different ratios. For instance, the shape of the housing 101 may be longer, wider, or thicker in comparison to the dimensions above for t, l, and w. The housing 101 may be made out of various materials, which may include plastic, fiber glass, rubber, and/or other suitable materials. For portable electronics, high-strength glass, polymers, and/or optionally light-weight metals (such as aluminum) may be used as part of the housing 101 to reduce the overall weight of the device. If the front panel 114 is a touch screen panel, a polymer (such as poly(methyl methacrylate)) or high-strength glass with conductive coating may be used in the housing 101. One or more antennas may be located around the edges 102 and may be made of conductive material suitable for RF signal radiation, such as metallic material, as described in more detail below.

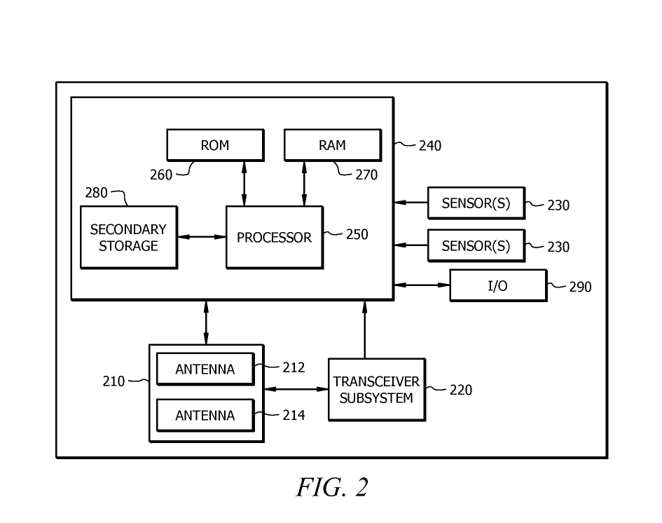

FIG. 2 is schematic showing certain components comprising an embodiment of a wireless communication device 200, for example, wireless communication device 100 of FIG. 1. The wireless communication device may be a wireless phone, such as a cell phone or smart phone, or a tablet computer as examples. The wireless communication device 200 comprises an antenna subsystem 210 having antennas 212 and 214, a transceiver subsystem 220, one or more sensors 230, a processing unit 240, a processor 250, a read only memory (ROM) 260, a random-access memory (RAM) 270, a secondary storage 280, and an I/O 290 configured as shown in FIG. 2.

The antenna subsystem 210 may comprise an antenna 212 and an antenna 214, and may further comprise a switch (not depicted) for selecting between antennas 212 and 214. Antennas 212 and 214 may share a common ground (not depicted). Antennas 212 and 214 may comprise any type of antennas that convert radio waves to electrical signals when in receive mode and/or that convert electrical signals to radio waves when in transmit mode, e.g., the antenna around edges 102 of FIG. 1. Antennas 212 and 214 may or may not be identical and/or symmetrical, and may have partially or fully overlapping communication frequency bands. In some embodiments, the antennas 212 and/or 214 may operate, for example, at one or more frequencies within the range of 824 and 2690 megahertz. However, the embodiments disclosed herein are not limited to these frequencies, but may be implemented to operate at other frequencies as well. The antenna subsystem 210 may be coupled to the transceiver subsystem 220.

The transceiver subsystem 220 may be a system that transmits digital information to and receives digital information from antenna subsystem 210 via electrical signals. The electrical signals may be centered at a specific RF, such as 1700 MHz or 2200 MHz. The transceiver subsystem 220 may comprise components for extracting digital data from an analog signal, such as a local oscillator, a modulator, and channel coder for transmission and a local oscillator, a demodulator, and channel decoder for reception. Some of these components may be implemented in a baseband processor within the transceiver subsystem 220. The transceiver subsystem 220 may compute received signal quality information, such as received signal strength indication (RSSI), and provide this information to the processing unit 240.

The processing unit 240 may be configured to receive inputs from transceiver subsystem 220, sensors 230, and I/O 290, and control a configuration of the antenna system 210, such as selecting between the antennas 212 and 214 therein. The processing unit 240 may be a separate unit from a baseband processor or may be a baseband processor itself. The processing unit 240 may include a processor 250 (which may be referred to as a central processor unit or CPU) that is in communication with memory devices including secondary storage 280, ROM 260, and RAM 270. Processor 250 may implement one or more steps similar to those in method 800 for estimating a head-relative handset location. The processor 250 may be implemented as one or more central processing unit (CPU) chips, or may be part of one or more application specific integrated circuits (ASICs) and/or digital signal processors (DSPs). The processor 250 may access ROM 260, RAM 270, and/or secondary storage 280, which may store head-relative handset location information for a wireless communication device, to determine a desired executional configuration based on information received from n sensors, such as sensors 230.

One or more sensors 230 may be configured for determining an orientation and/or an environment of the wireless communication device 200. The orientation may be a tilt or rotation relative to a vertical direction, and the environment may be an indoor or outdoor environment, as examples. The sensors 230 may include one or more accelerometers, magnetometers, gyroscopes, tilt sensors, other suitable sensors for measuring angular orientation, a proximity sensor, or any combination or permutation thereof. Proximity sensors are well known and include optical, capacitive, ultrasonic or other proximity sensors. Sensors 230 may include one or more sensors for measuring received signal quality, e.g., RS SI.

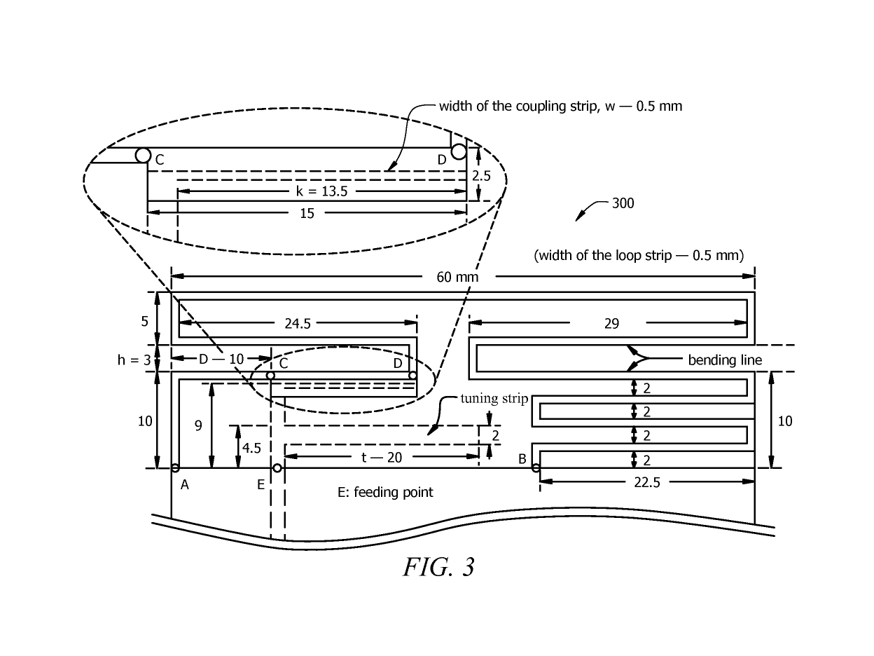

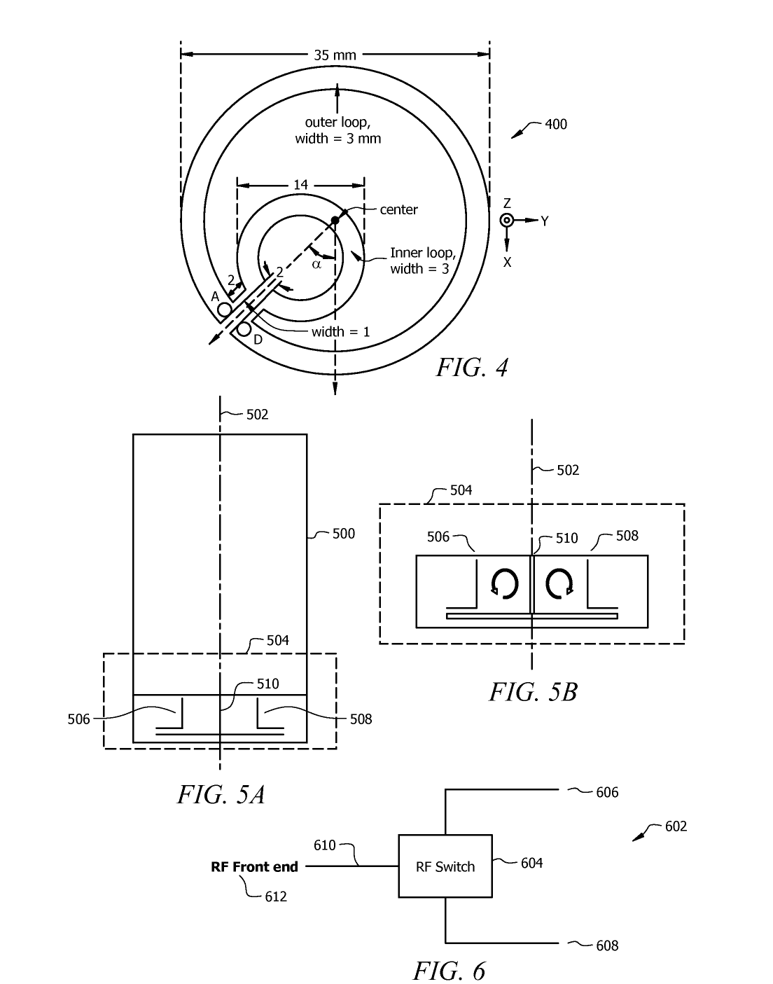

FIG. 3 is a seven-band surface-mount loop antenna with a capacitively coupled feed for mobile phone applications. FIG. 3 shows a single capacitively coupled loop antenna 300. FIG. 4 is a printed, dual-polarized dual-loop antenna for 2.4 GHz and 5 GHz WLAN access points. FIG. 4 shows a dual loop antenna 400 having a single feed, with one loop of the feed contained entirely within the other. The antennas depicted in FIGS. 3 and 4 and other designs take different approaches to optimizing antenna efficiency. For example, the antenna 300 may simultaneously use a bottom and top antenna to connect both antennas to one or another transceiver all the time. Other solutions enable a single antenna structure to behave like multiple antennas through the use of multiple feed points using different modal excitation of a single radiating element structure.

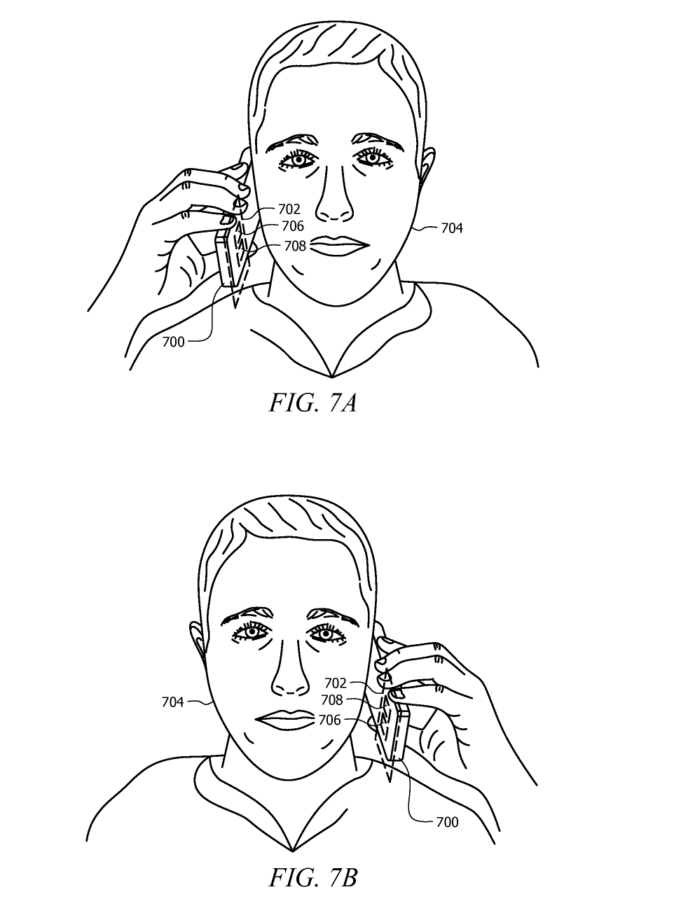

FIG. 5A depicts a rear view of a wireless communication device 500 having an embodiment of a dual feed antenna system. Wireless communication device 500 has a centerline 502 and is shown with antenna subsystem 504, which is shown in a detail view in FIG. 5B. Antenna subsystem 504 may comprise feed A 506, feed B 508, and T-shaped ground leg 510. The components of FIG. 5 may be substantially similar to the components of FIG. 2, wherein wireless communication device 500 corresponds to wireless communication device 200, antenna subsystem 504 corresponds to antenna subsystem 220, feed 506 corresponds to antenna 212, and feed 508 corresponds to antenna 214. Feed 506 may be a separate antenna with a generally symmetric construction with respect to feed 508. In some embodiments, antenna subsystem 504 may occupy the same volume in wireless communication device 500 as conventional antenna subsystems.

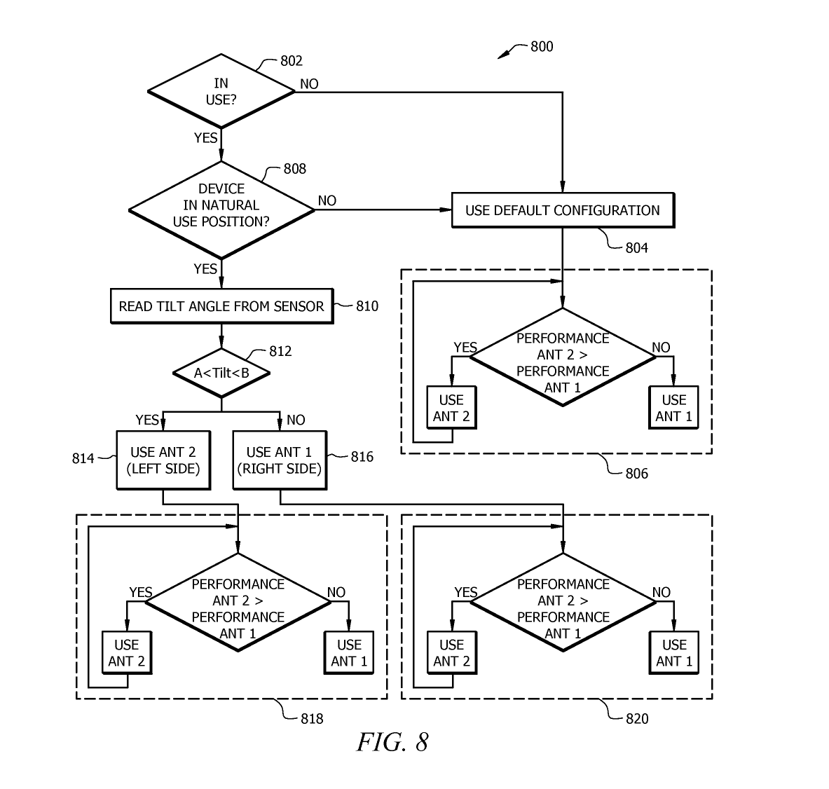

FIG. 6 depicts a schematic diagram of an antenna subsystem 602 having a grounded RF switch 604, also referred to herein as a selection switch, common to feed 606 and feed 608. The antenna subsystem 602 may be substantially similar to the antenna subsystem 504 of FIG. 5, with feed 606 corresponding to feed 506 and feed 608 corresponding to feed 508. Positioned between feeds 606 and 608, the antenna subsystem 602 contains an RF switch 604 comprising the trace 610, e.g., an electrical or RF trace, also referred to herein as an RF line. The trace 610 may run to the RF front end 612, which may correspond to transceiver subsystem 220 of FIG. 2. RF switch 604 may select between using either feed 606 or feed 608 based on input from the RF front end 612.

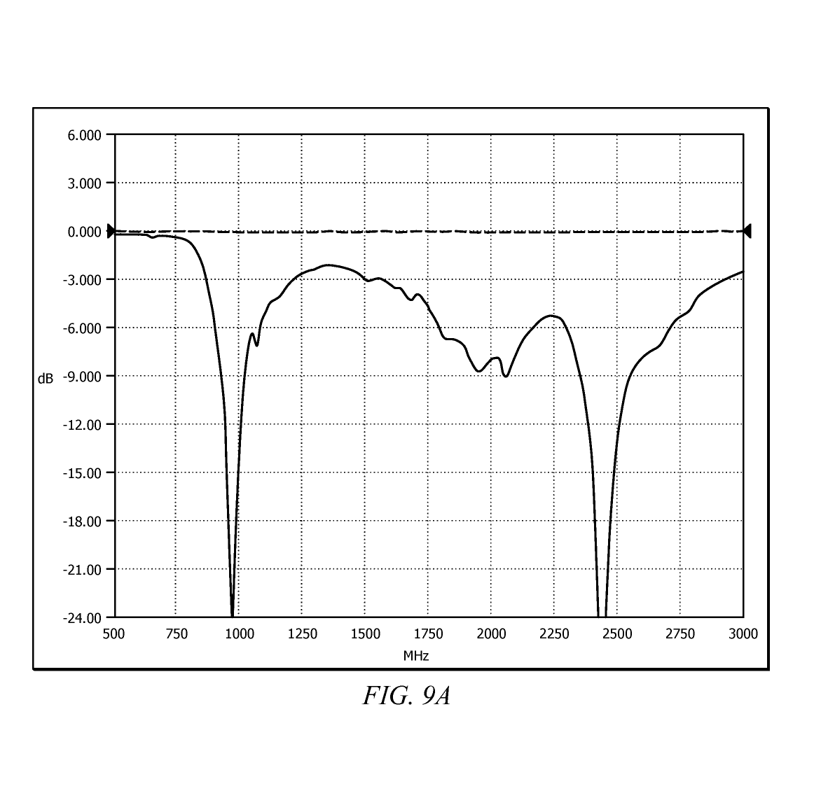

FIG. 7A depicts a wireless communication device 700 having a dual feed antenna subsystem 702 proximate to the right side of a head 704. FIG. 7B depicts a wireless communication device 700 having a dual feed antenna subsystem 702 proximate to the right side of a head 704 proximate to the left side of a head 704. The dual feed antenna subsystem 702 comprises feeds 706 and 708. The components of FIGS. 7A and 7B may be substantially similar to the components of FIG. 5, wherein the wireless communication device 700 corresponds to the wireless communication device 500, the dual feed antenna subsystem 702 corresponds to the antenna subsystem 504, and feeds 706 and 708 correspond to feeds 506 and 508. For ease of reference and without limitation, positions depicted in FIGS. 7A and 7B, including a range of positions wherein the wireless communication device 700 is proximate to a user's head and has a centerline generally running from about the user's ear to about the user's mouth when the user's head is in a generally vertical position, may be referred to herein as the natural use position. In FIG. 7A, feed 706 is located in a relatively higher, less obstructed location, e.g., away from the palm of the user's left hand, while feed 708 is located in a relatively lower, more obstructed location, e.g., closer to the palm of the user's left hand. In FIG. 7B, feed 708 is located in a relatively higher, less obstructed location, e.g., away from the palm of the user's right hand, while feed 706 is located in a relatively lower, more obstructed location, e.g., closer to the palm of the user's right hand.

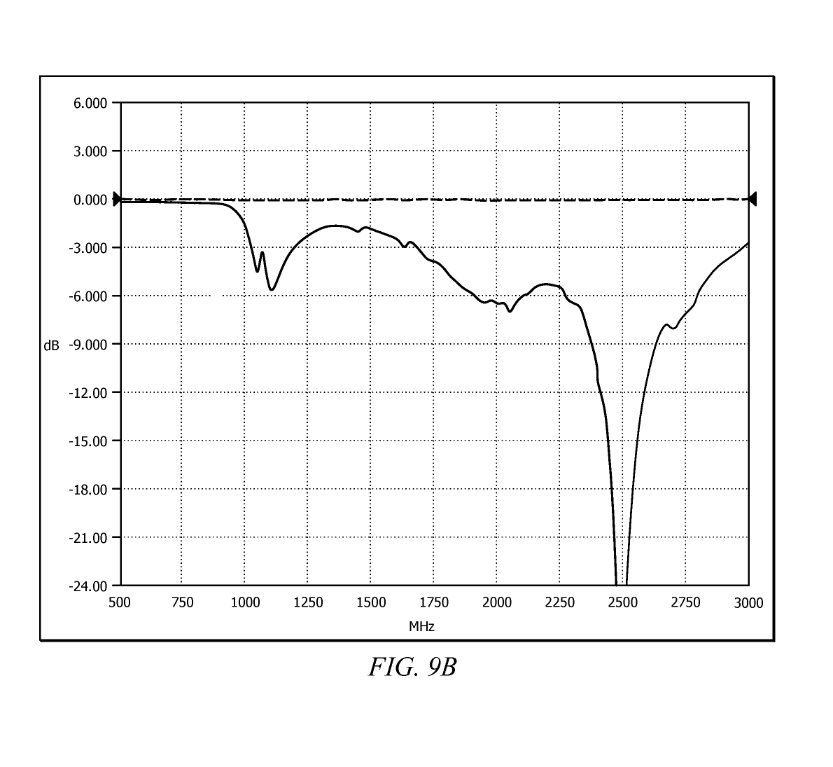

FIG. 8 depicts a flowchart of an embodiment of a method for a dual feed antenna system. Broadly, FIG. 8 depicts a process 800 wherein a wireless communication device, e.g., wireless communication device 700 of FIG. 7, determines whether the wireless communication device is in use. If so, the natural use position may be determined and an optimized use configuration is utilized. If not, a default standby configuration may be entered. Both the use and standby configurations may include feedback loops to readjust the respective configuration based on historic and/or real-time performance data. Process 800 begins at 802 with a wireless communication device determining whether the wireless communication device is in use, e.g., on a telephone call. If the wireless communication device is not in use, an antenna default configuration may be entered at 804. The default configuration may use a first antenna, e.g., feed 706 of FIGS. 7A and 7B, by default if no performance data is available. At 806, the wireless communication device may review the relevant performance data, e.g., RSSI/received signal quality, and select between using a first or second antenna, e.g., feed 706 or feed 708 of FIGS. 7A and 7B, based on the performance.

Returning to 802, if the wireless communication device is in use, the method 800 may proceed to 808. At 808, the wireless communication device may determine whether the wireless communication device is in a natural use position, e.g., by verifying that the proximity sensor is on, and that the speakerphone, headset and handsfree devices are off. If the wireless communication device is in a natural use position, the antenna default configuration may be entered at 804. If the wireless communication device is in a natural use position, the tilt angle may be read from a sensor, e.g., sensor 230 of FIG. 2, at 810. Based on the measured tilt angle, at 812 the wireless communication device may determine whether the wireless communication device is in a right-side or left-side natural use position. If the wireless communication device is in a right-side natural use position, the first antenna, e.g., feed 706 of FIGS. 7A and 7B, may be selected for use at 814. If the wireless communication device is in a left-side natural use position, the second antenna, e.g., feed 708 of FIGS. 7A and 7B, may be selected for use at 816. As with the default configuration, following selection of the first or second antenna at 814 or 816, a feedback protocol may be employed at 818 and 820 for 814 and 816, respectively, to ensure continued optimized performance.

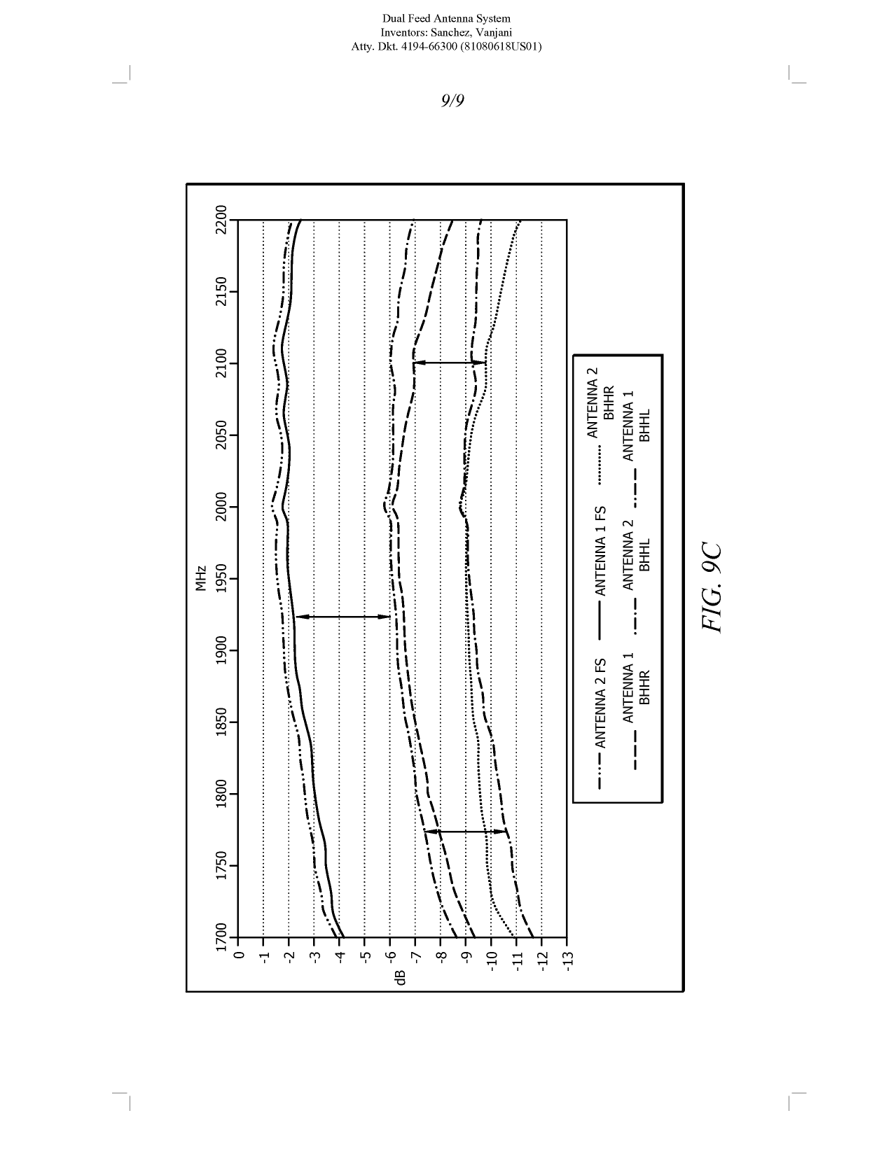

FIG. 9A is a return loss plot depicting free space return loss of a first antenna, e.g., the first antenna of FIG. 8, over a range of frequencies. The first antenna of FIG. 9A is configured to transmit on a low band, e.g., about 900 MHz, and a high band, e.g., about 1800 MHz. FIG. 9B is a return loss plot depicting free space return loss of a second antenna, e.g., the second antenna of FIG. 8, over a range of frequencies. The second antenna of FIG. 9B is configured to transmit on a high band, e.g., about 1800 MHz. The high bands of the first and second antennas of FIGS. 9A and 9B overlap. The y-axes of FIGS. 9A and 9B show return loss in decibels (dB). The x-axes of FIGS. 9A and 9B show frequency in MHz.

FIG. 9C is a plot depicting the high band antenna efficiency of the first and second antennas of FIGS. 9A and 9B in free space, in obstructed real-world, and in non-obstructed real-world environments. The y-axis of FIG. 9C shows antenna efficiency in dB. The x-axis of FIG. 9 shows frequency in MHz. Three measurements are depicted for each antenna: (1) free space (FS), (2) beside head and hand, right side (BHHR), and (3) beside head and hand, left side (BHHL). The BHHR and BHHL positions may correspond to the wireless communication device orientations depicted in FIG. 7A and 7B, respectively, with the first antenna corresponding to antenna 708 and the second antenna corresponding to antenna 706. In the BHHR position, the first antenna is relatively more obstructed by the user's head and/or hand and the second antenna is relatively less obstructed. In the BHHL position, the second antenna is relatively more obstructed by the user's head and/or hand and the first antenna is relatively less obstructed. FIG. 9C shows the efficiency for both antennas increasing by a noticeable amount, e.g., reducing losses by about half from the obstructed position to the FS position and/or about 3 dB, when shifted from an obstructed to a non-obstructed position. Consequently, by selectively utilizing the non-obstructed antenna for communication, a dual feed antenna system may provide greater overall antenna efficiency.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term about means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An wireless communication device comprising:
a plurality of antennas; and
a selection switch coupled to the plurality of antennas, wherein the selection switch is configured to select a first antenna for use when the wireless communication device is in use in a first physical orientation with respect to a user, and select a second antenna for use when the wireless communication device is in use in a second physical orientation with respect to a user, and wherein the first physical orientation is different from the second physical orientation.

2. The wireless communication device of claim 1, wherein the plurality of antennas are configured to transmit on overlapping frequencies.

3. The wireless communication device of claim 1, wherein the first physical orientation with respect to a user is proximate to a user's head.

4. The wireless communication device of claim 1, wherein the first physical orientation with respect to a user is proximate to the right side of a user's head and the second physical orientation is proximate to the left side of a user's head.

5. The wireless communication device of claim 1, wherein the first physical orientation with respect to a user is proximate to a user's hand.

6. The wireless communication device of claim 1, wherein the antennas are physically oriented on opposing sides of the wireless communication device.

7. The wireless communication device of claim 1, wherein the antennas are symmetrical.

8. An apparatus comprising:
a common ground line;
a first loop antenna configured to communicate using a first frequency, wherein the first loop antenna comprises a first feed line coupled to the common ground line;
a second loop antenna configured to communicate using the first frequency, wherein the second loop antenna comprises a feed line coupled to the common ground line; and
a selection switch coupled to the first loop antenna, the second loop antenna, and an antenna front end, wherein the selection switch is configured to select between use of the first loop antenna or second loop antenna.

9. The apparatus of claim 8, wherein the first loop antenna and second loop antenna are symmetrical.

10. The apparatus of claim 8, wherein the first and second feed lines are coupled via directly connecting both the first and second feed lines, via capacitively coupling both the first and second feed lines, or via directly connecting the first feed line and capacitively coupling the second feed line.

11. The apparatus of claim 8, wherein the first loop antenna and second loop antenna are arranged on opposing sides of a wireless communication device.

12. The apparatus of claim 8, wherein the first loop antenna is configured to communicate using broader frequency range than the second loop antenna.

13. The apparatus of claim 8, wherein the first loop antenna is configured to communicate using the same frequency range as the second loop antenna.

14. The apparatus of claim 8, wherein the selection switch is further configured to select the first loop antenna for use when the first loop antenna is relatively physically higher off the ground than the second loop antenna, and select the second loop antenna for use when the second loop antenna is relatively physically higher of the ground than the first loop antenna.

15. The apparatus of claim 8, wherein the selection switch is further configured to select the first loop antenna for use when the received signal quality associated with the first loop antenna is relatively higher than the received signal quality associated with the second loop antenna, and select the second loop antenna for use when the received signal quality associated with the second loop antenna is relatively higher than the received signal quality associated with the first loop antenna.

16. A method of communicating on a wireless communication device comprising:
configuring a wireless communication device to communicate using a first antenna on a first frequency;
receiving input from a sensor, wherein the sensor provides indication of a physical orientation of the wireless communication device with respect to a user; and
reconfiguring the wireless communication device to communicate using a second antenna on the first frequency based on the input from the sensor.

17. The method of claim 16, wherein the sensor is selected from a group consisting of: a position sensor, a tilt sensor, a gyroscope, an accelerometer, a proximity sensor, and a received signal quality sensor.

18. The method of claim 16, wherein the first and second antenna are positioned at opposing sides of the wireless communication device.

19. The method of claim 16, wherein the first and second antenna are symmetrical.

20. The method of claim 16, further comprising:
monitoring input from the sensor; and
selectively reconfiguring the wireless communication device to communicate using the first antenna on the first frequency when input from the sensor indicates improved communication using the selective reconfiguration.
